(19) United States
(12) Patent Application Publication
(10) Pub. No.: US 2004/0225579 A1
(43) Pub. Date: Nov. 11, 2004

(54) Method for scheduling and inventory management for a process

(76) Inventors: Galen O. Peery, Kiron, IA (US); Julie K. Marron, Holstein, IA (US); Robert L. Daiker, Odebolt, IA (US); Bruce P. Olson, Ida Grove, IA (US); Clifford M. Gebel, Ida Grove, IA (US); Ryan E. Hudson, Ida Grove, IA (US)

Correspondence Address: STURM & FIX LLP, 206 SIXTH AVENUE, SUITE 1213, DES MOINES, IA, 50309-4076, US

(21) Appl. No.: 10/431,310

(22) Filed: May 7, 2003

(51) Int. Cl. G06F 17/60

(52) U.S. Cl. 705/28

(57) ABSTRACT

Managing manufacturing or other process is dependent on inventories of finished product. Inventories of final products are reviewed on a strictly periodic basis, the period being uniquely determined for that product at that time. When an inventory is found to be below a predetermined limit, a manufacturing run is proposed. The schedule for that manufacturing run is determined based on the process required for that product, and the capacity limitations of one or more of the processing steps. The demands of a processing step should not exceed its capacity. A Drum Buffer Rope scheduling method is used for this manufacturing run scheduling to keep it within the bounds set by the capacity-constrained resource(s).

### BACKGROUND OF THE INVENTION

1. Field of the Invention

The present invention relates generally to process management. More particularly the present invention relates to a method for scheduling processes and replenishing inventory associated with those processes.

2. Background Art

Many schemes have been devised for managing a process such as the manufacture of a product. Some of the aspects of this management are allocating appropriate times for each step in the process and assuring that material is available when and where it is needed for the process. What is more, every process has limitations or “bottlenecks,” referred to as capacity-constrained resources that limit the overall process. Scheduling must be carried out in light of these constraints.

Part of managing a process is determining when to carry out the process and how much of the process to carry out. In terms of manufacturing, the questions are: “When should a run of a particular product be made?” and “How many of this particular product should be produced at this time?” These questions are questions of inventory of the product in question.

Many schemes have been devised, such as KanBan, “Order Point” and “Order Up To,” for inventory control. Inventory is herein defined loosely, comprising the raw materials needed for the process as well as partially finished and finished products produced in the process. Inventory is directly connected to production. The inventory of finished or partially finished products determines when a run of production of that product is expedient. Some schemes for determining an appropriate time for a production run and the extent of that run look only at a present inventory as compared to a benchmark. In other words, when the inventory of a product drops below a certain quantity of the benchmark, it is deemed time to make a production run. The size of the run is based on the actual quantity of the inventory compared to the benchmark. Difficulties arise due to this approach. Some difficulties are that the inventory must be reviewed often, typically each day; orders for similar items are not scheduled for the same day causing inefficiencies; and orders can be scheduled multiple days for the same item. Another difficulty is that this approach does not conform to variations such as seasonal business cycles wherein at times crossing the line indicating a production run is necessary may mean that production run must begin immediately to avoid selling out all existing inventory before the run is complete, while at other times, the rate at which inventory is depleted is much slower, allowing more time for the production run.

Materials needed to carry out the process, such as manufacturing a product, are managed by an inventory management scheme. The inventories of these materials are closely related to the process, itself, yet usually only existing inventories are reviewed to determine whether restocking is necessary.

At present, Drum rope buffer system and most other replenishment system tools used for the management of a process and the management of inventory are separate from one another, and between which information is not directly shared. An operator must make the connection between the process and the inventory required for or resulting from the process.

There is, therefore, a need for a method of managing a process that takes into consideration variations in business cycles. Another need is for a method of managing a process that does not require monitoring inventory more frequently than necessary. Still another need is for linking the process management method with a method for managing inventory to make purchasing more accurate.

### SUMMARY OF THE INVENTION

A broad objective of the present invention is to reduce the inventory of raw materials and finished materials required by a processor or manufacturer while improving response times for filling orders. To accomplish this broad objective, a purpose of the present invention is to minimize the frequency at which the inventory of a “final” product, either finished or partially finished for further processing later; or for use in a finished consumer product, must be reviewed based on past history and projections for this product. Production of the product is based, then, on the time frequency at which its inventory is reviewed. Another purpose is to determine the inventory requirement for a product by taking into account its lead time (time required for manufacture), its order cycle (period of inventory review), the travel time to its destination (warehouse or dealer, etc.), its demand pattern (average sales for the period of review), and a seasonality factor (taking into account seasonal variations, if any, of the product's sales).

Still another purpose of the present invention to achieve the broad objective, above, is to effectively couple the tools used for managing a process and managing the inventory for that process. The inventory of the “raw” materials used for the process, including materials already processed in-house or elsewhere, can then be managed based on production, and, thus, use of the raw materials; while the inventory of the final product may be coordinated with the management of production and vice versa.

The supply chain replenishment process is based on the history of the inventory of a final product, where “product,” might be a tangible product or a service requiring resources needing to be managed. An inventory review period is determined. The inventory review period is determined by the desired frequency of scheduling/producing the items. Some examples of factors used to determine the frequency of orders are machine setup time, volume of product to be built, inventory strategies, and process cycle time but not limited to these. The method of the present invention, then, would compare the inventory of the final product to a benchmark known as the “Top Of Buffer” (TOB) for the particular product only periodically, at a frequency determined appropriate. If the inventory of this final product is not below a predetermined percentage of the TOB, no action is taken. If, however, the present inventory has dropped below the predetermined percentage of the TOB, a manufacturing or process run is planned.

The TOB value for a particular product takes into account several aspects of the manufacturing and sales characteristics of the product comprising:

Lead time

Order cycle

Travel time

Demand pattern

Safety Factor

Seasonality factor

These aspects, and any others deemed important, combine to give an accurate and dynamic maximum inventory goal.

It is recognized that carrying out a process to produce a product depletes inventories of raw materials, or materials used to produce the product, while increasing the inventory of the final product. Therefore, the most accurate indicator of the need for purchasing raw materials and the need to increase the stock of final goods is production. Therefore, it is expedient that tools used to perform production scheduling, inventory management, order filling, and raw material purchasing should be linked to communicate with one another. In this way, by monitoring production, the purchase raw materials may be recommended and automated for the purchaser. By coupling orders filled with production information and shipping information, accurate management of the inventory of final products may be effected.

The novel features which are believed to be characteristic of this invention, both as to its organization and method of operation together with further objectives and advantages thereto, will be better understood from the following description considered in connection with accompanying figures in which a presently preferred embodiment of the invention is illustrated by way of example. It is to be expressly understood however, that the drawings are for the purpose of illustration and description only and not intended as a definition of the limits of the invention.

### BRIEF DESCRIPTION OF THE DRAWINGS

FIG. 1 is a flow diagram showing the movement of goods and data to and from a manufacturer;

FIG. 2 is a connectivity chart showing the linking of a software tool implementing the present invention and third party software;

FIG. 3a is a flow chart for a calculation of a Top Of Buffer;

FIG. 3b is a flow chart for a calculation of a lower inventory limit or red line;

FIG. 4 is an x-y plot of a seasonal variation in sales of a product, and its average, annual sales value;

FIG. 5 is an x-y plot of a Top Of Buffer, lower inventory limit, and present inventory of a product;

FIG. 6 is a flow diagram of a supply chain replenishment process for a final product;

FIG. 7 is a flow diagram of a supply chain replenishment process for raw materials for manufacture or processing;

FIG. 8 is a schematic of a manufacturing schedule based on Drum Buffer Rope scheduling; and

FIGS. 9-31 illustrate a presentation explaining the present invention.

### BEST MODE FOR CARRYING OUT THE INVENTION

The method of the present invention may be implemented in software to run on a computer or computer network.

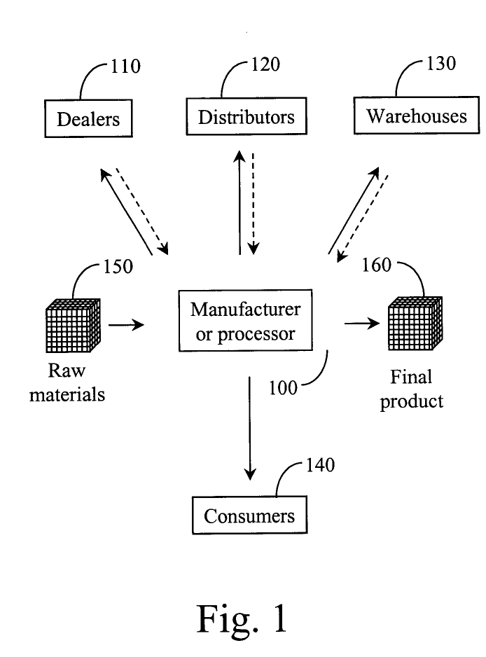

A flow diagram is shown in FIG. 1. The manufacturer 100 of the goods in question is shown in the middle. As indicated by the solid arrows, final products may be moved to any number of clients, on a list comprising

Dealers 110 (retailers)

Distributors 120 (wholesalers)

Warehouses 130 (manufacturer's)

Consumers 140 (direct sales)

Of course, dealers and distributors may include those combining the product with other products to create a package, or they may sell the product stand-alone.

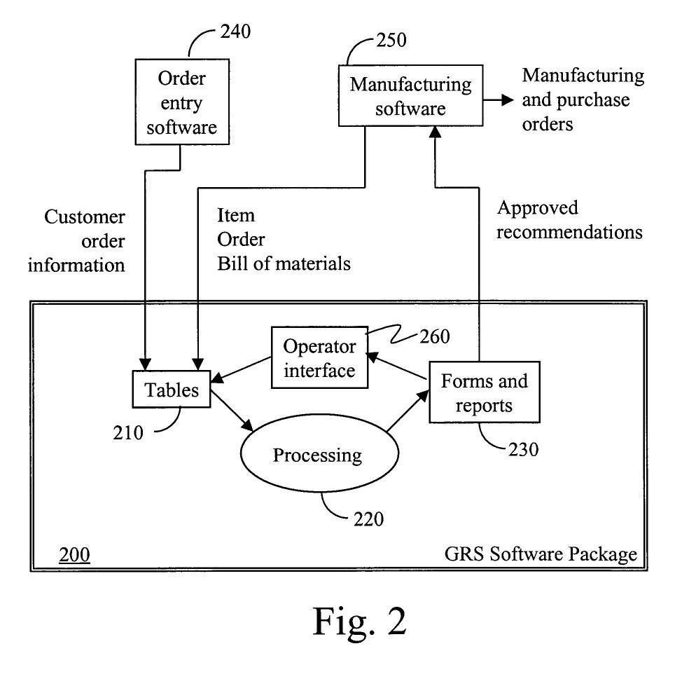

Orders, sales, and inventory information, indicated by the dashed arrows may be conveyed back to the manufacturer 100 from the dealers 110, distributors 120, and warehouses 130. This information would, preferably, be communicated electronically such that a Global Replenishment System (GRS) software package 200 (FIG. 2) receives it and makes use of it. However, the information coming from the dealers 110, distributors 120, and warehouses 130 may also be received and entered, directly or indirectly, into the GRS software package by an operator.

Also shown in FIG. 1 is the movement of materials through the manufacturer's 100 facility from raw materials 150 to a final product 160. It should be emphasized that the final product may not be a finished, consumer product, but could be a part of another manufacturer's product. For example, such a final product is a printed circuit board to be used in consumer electronics.

In FIG. 2, the method of the present invention is shown implemented in a GRS software package 200. The GRS software package 200 comprises three functions:

1. Tables 210

2. Processing 220

3. Forms and reports 230

The tables function 210 contains data from linked sources and from external sources from which data were imported manually or otherwise. Linked sources comprise order entry software 240, such as packages produced by Soft Brands, SAP, Oracle, and JD Edwards; and manufacturing software 250, like those of Soft Brands, SAP, and JD Edwards.

As indicated in FIG. 2, data shared from the order entry software 240 comprises information about customers'orders, while the data the GRS software package 200 receives from the manufacturing software 250 comprises item, order, and bill of materials information.

The processing function 220 within the GRS software package 200 represents the number crunching and logic steps of the program to produce the necessary output.

The GRS software forms and reports function 230 takes the data produced by the program's processing function 220 and formats them in a useful fashion for the operator. Information includes warnings due to low inventories or other resources, preliminary schedules, and purchase recommendations.

An operator interface 260 is not considered a separate function, but a module providing a pathway for information between an operator and the GRS software package 200.

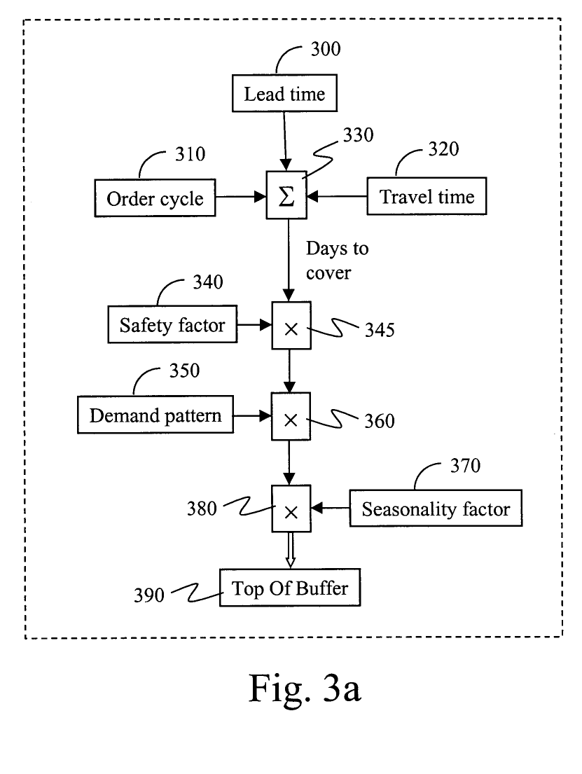

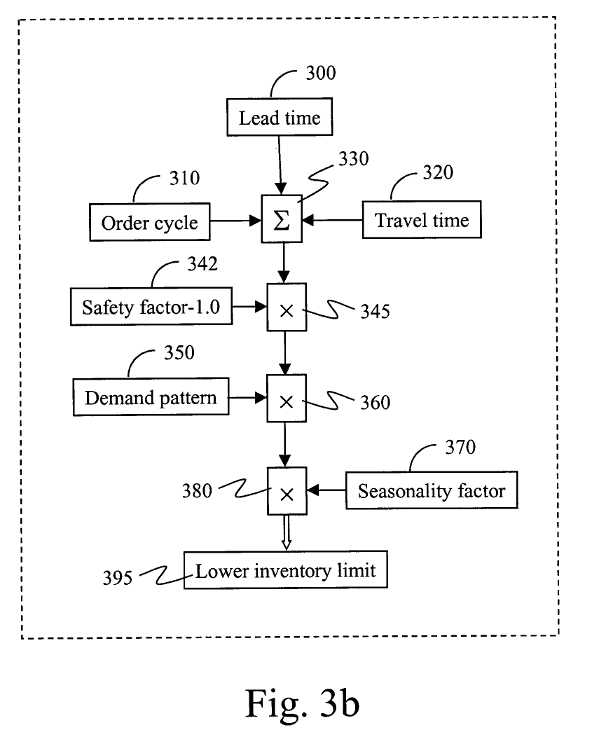

Suitable formulas for calculating an upper inventory limit, or Top Of Buffer (TOB), and a lower inventory limit, sometimes referred to as the “red line” limit, are important for the present invention. An example calculation for the TOB 390 of a particular product or product line is shown in FIG. 3a. A summation of the lead time 300, order cycle 310, and travel time 320, is formed in a summation block 330. This sum is then multiplied by a safety factor 340 in a first multiplication block 345 and a value representing a demand pattern 350 for the product in a second multiplication block 360. This last product is multiplied by a seasonality factor 370, if any, in a second multiplication block 380, and the result is the TOB value 390. Other methods for calculating the TOB value 390 may be used, and this invention is not limited to the one shown in FIG. 3a.

The lead time 300 is the time span required to ready a product for delivery once the manufacture order is approved. This time would naturally include the times required for the various manufacturing steps, inspection, possibly some “padding” to account for unknowns or unforeseen incidents, and preparation for shipping.

The order cycle 310 is the period at which the inventory of the product is reviewed.

The travel time 320 is limited to the time for shipping goods from the manufacturer to the final destination. It does not include packaging and preparation for shipping, as these are included in the lead time 300.

The safety factor 340 provides a way to manipulate the end result of the calculation to account for uncertainties and the realities of business without artificially altering the other values in the summation.

The demand pattern 350 is the annual demand for the product divided by available production time based on the time frame (units per hour, units per week) used to schedule inventory replenishment.

Another value, the lower inventory limit 395, is calculated in a fashion very similar to the Top Of Buffer value. The process is shown in FIG. 3b. In this flow diagram, instead of the safety factor 340, the safety factor 340 less unity (1.0) is used as a factor. The result is the lower inventory limit 395, as shown at the bottom of the chart.

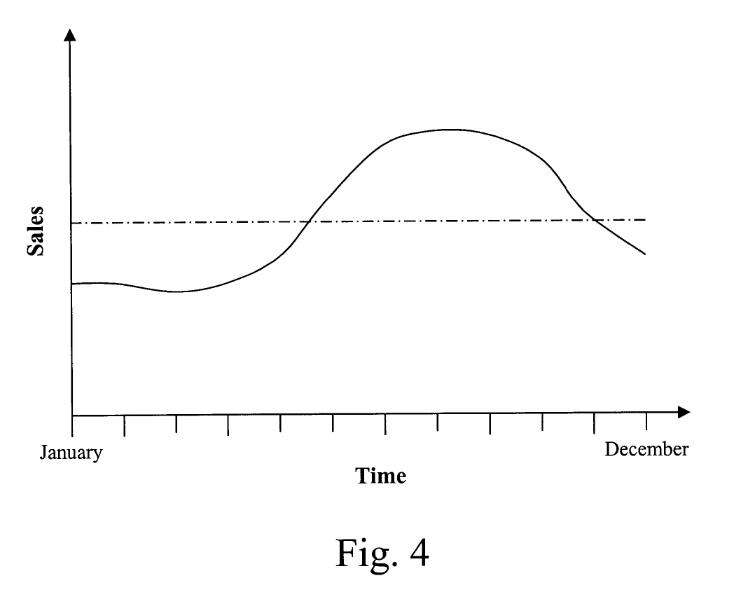

Not all products are seasonal, but many are. The seasonality factor 370 helps to eliminate the need to maintain an inventory calculated for the busiest time of the year, all year long. A plot of the sales of a product over a year is shown in FIG. 4. The solid line represents the actual sales, and would best be represented by an ensemble average. The dot-dashed line is an annual average of the sales of the product, averaged over the entire year as follows:

$$Annual Average = \frac{{\int }_{year}^{} sales ⅆ t}{{\int }_{year}^{} ⅆ t}$$

To calculate the seasonality factor 370 as used in the calculation of FIG. 3, the ordinate of the plot in FIG. 4 is normalized:

$$Seasonality Factor = \frac{Ensemble Average of Sales}{Annual Average of Sales}$$

so, the annual average value indicated by the dot-dashed line is unity (1.0) and the solid line, then, becomes the seasonality factor 370.

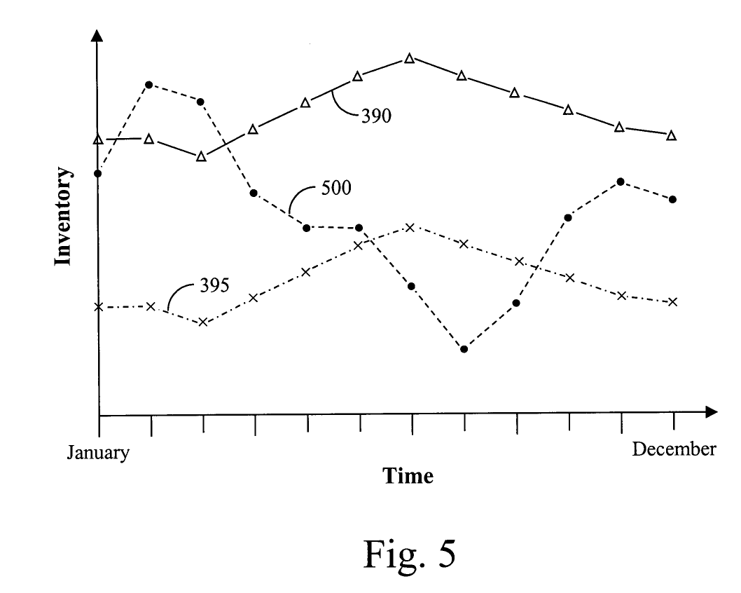

A plot of actual inventory 500 of a final product is shown in FIG. 5, plotted using a dashed line with solid circles at each month. The TOB value 390, as calculated using an algorithm such as that shown in FIG. 3a, is plotted using solid lines with triangles at each month. Note that this value may vary throughout a time period, such as a year, as shown in FIG. 5. Other time periods, such as quarters or months may be appropriate for some products. The lower inventory limit 395 is also plotted in FIG. 5. The lower inventory limit 395 may be calculated using an algorithm such as that shown in FIG. 3b.

The goal of the present invention is to minimize inventories while still maintaining the ability to meet customers' needs in an expedient fashion. Therefore, the actual inventory 500 should remain at or below the TOB value 390, while being at or above the lower inventory limit 395. It can be seen that the inventory 500 of this particular product rose above the TOB 390 for about two months early in the year. This represents inefficiency because, if the TOB values 390 are calculated accurately, inventories 500 above the TOB 390 are unnecessary.

The inventory 500 also dropped below the minimum inventory limit 395 near July and continued for about three months. During this period, if the minimum inventory limit 395 is calculated accurately, there is a risk that customer's orders will not be filled in a timely fashion because adequate stock is not available for shipping. Throughout the remainder of the year, the inventory 500 is shown to reside between the TOB 390 and the minimum inventory limit 395 as desired.

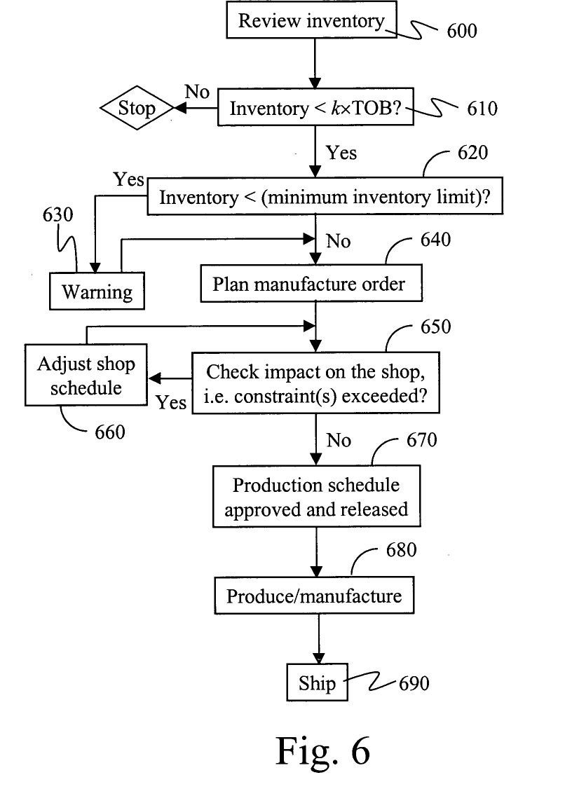

Periodically, when the time arrives to review the present inventory of a product or product line, a supply chain replenishment process, illustrated in FIG. 6, is carried out. The first step is to determine the present inventory, as indicated by the inventory review block 600, and compare that to the TOB value 390 as shown in a first comparator block 610. A multiplier, k, on the TOB value may be used to avoid very small manufacturing runs (k≦1). If the instantaneous inventory is not less than kxTOB, no further action need be taken.

An additional comparison, carried out in a second comparator block 620, is used to determine if a warning 630 should be issued that the inventory has dropped below the minimum inventory limit 395. An operator may initiate an expedited manufacture order to quickly remedy this lack.

Irrespective of the output of the second comparator block 620, a preliminary plan 640 for production or manufacture is suggested. According to the Theory of Constraints, every process has at least one capacity-constrained resource limiting the ability to reach a given goal. In Drum Buffer Rope Scheduling, process scheduling is done with the capacity-constrained resource(s) in mind. It does no good to schedule a process that exceeds the available resource. So, with the preliminary plan 640 for manufacture in hand, a check 650 must be made to assure that the production run can be carried out under the capacity-constrained resource(s) of the production process. This check 650 must be made in light of other production runs being executed at the same time. If a conflict occurs, that is, if the capacity of the production line is insufficient, an adjustment, such as a shop schedule adjustment 660, must be made. This adjustment might comprise shifting a job or part of a job to a time when resources are not as limited, adding personnel or other resources to bolster the capacity-constrained resource of the production line, or having personnel work overtime.

Once the preliminary manufacture order 640 has been adequately adjusted, the manufacture order is approved 670 and the goods produced or manufactured 680. The final step is shipping 690.

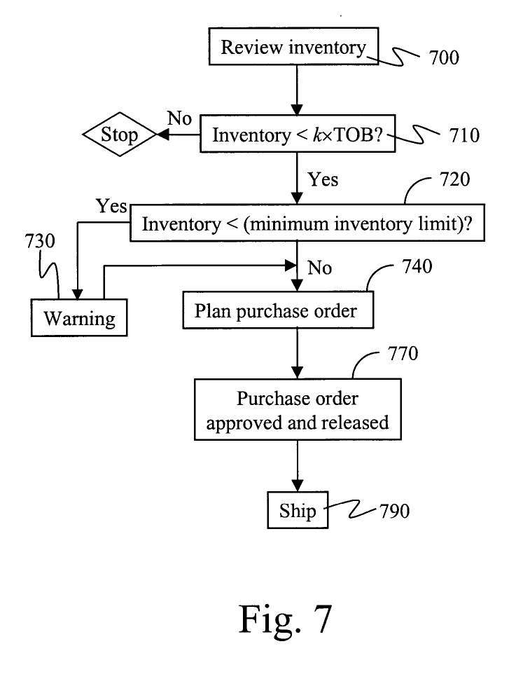

Replenishing the raw materials used in manufacturing or processing a product follows a similar logic as that, illustrated in FIG. 6. The analogous process for raw materials is shown in FIG. 7. As before, the first step is to determine the present inventory, as indicated by the inventory review block 700, and compare that to the TOB value 390 as shown in a first comparator block 710. To avoid very small purchases, a multiplier, k, on the TOB value may be used (k≦1). If the instantaneous inventory is not less than kxTOB, no further action need be taken.

An additional comparison, carried out in a second comparator block 720, is used to determine if a warning 730 should be issued that the inventory has dropped below the minimum inventory limit 395. An operator may initiate an expedited purchase order to quickly remedy this lack.

Regardless of the output of the second comparator block 720, a preliminary plan 740 for purchase is suggested. Once the preliminary purchase order 740 has been reviewed, the purchase order is approved and released 770. The final step is shipping 790.

By tracking raw material stocks, purchase orders may be constructed and recommended by the software by which the present invention is carried out. Except for approval (see FIG. 2) by an operator or someone in authority, the purchase ordering process may be completely automated.

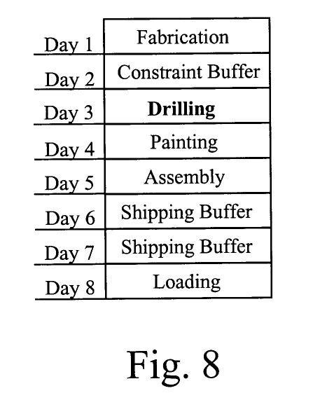

A manufacturing schedule for a product requiring the cutting of parts, drilling, painting, assembly, and shipping preparation is shown in FIG. 8. By using Drum Buffer Rope Scheduling, careful note was taken that the drilling process (Day 3) was the capacity-constrained resource, and a buffer day (Day 2) installed leading up to this step to make sure all the parts have been fabricated and are ready for the drilling process at the start of the shift. When it is determined that a manufacturing run of the product whose manufacturing process schedule is shown in FIG. 8 must be made, it is known, immediately the minimum time before the additional final product inventory will be available. Once a preliminary schedule 640 is approved, the lead time is firmly established for that product at that time.

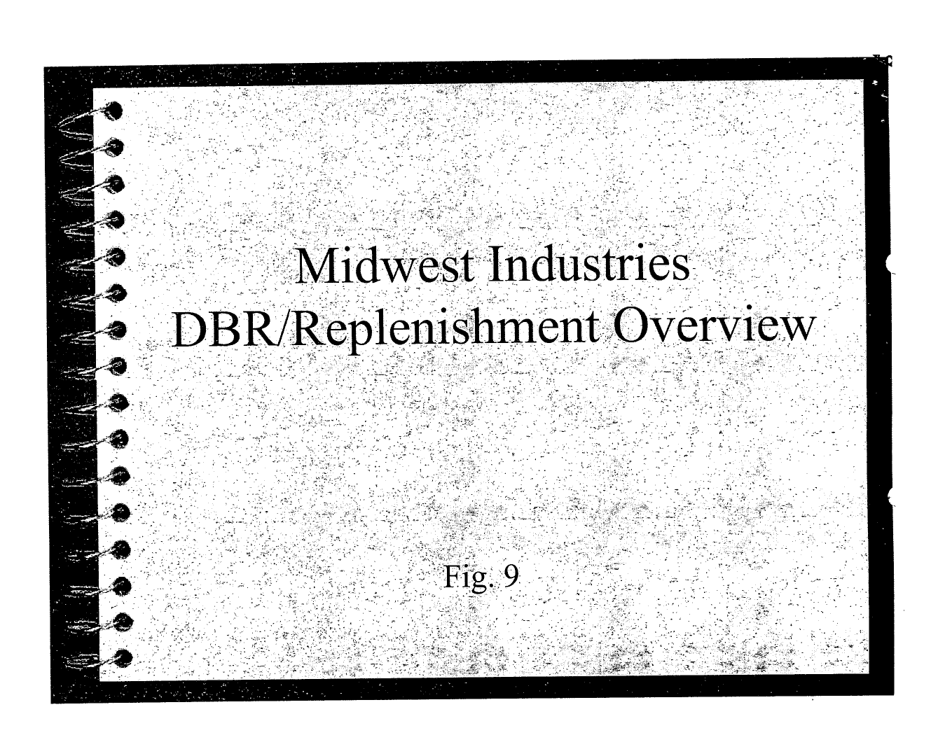

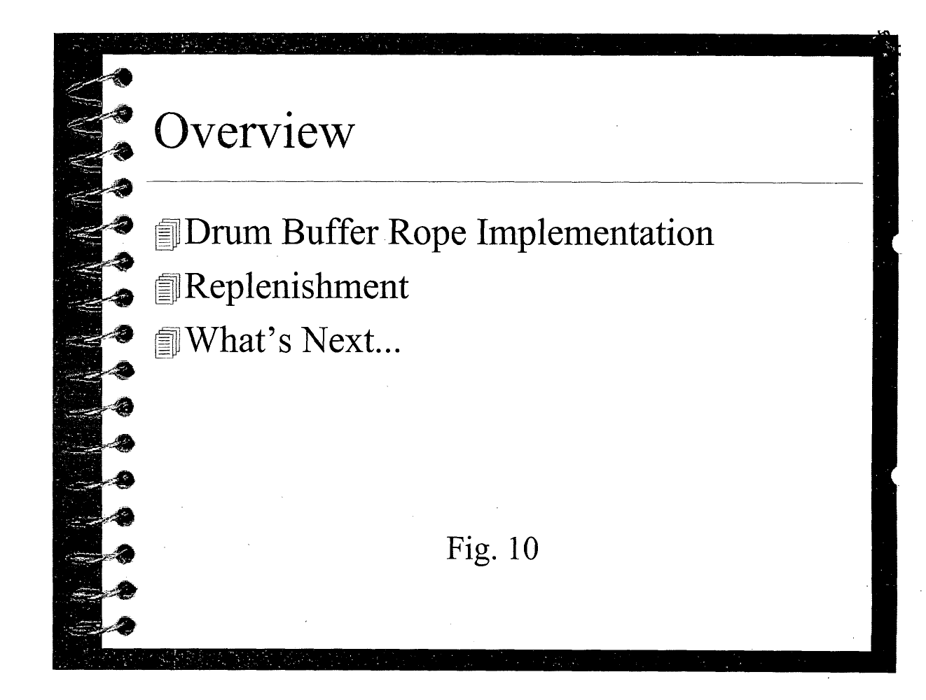

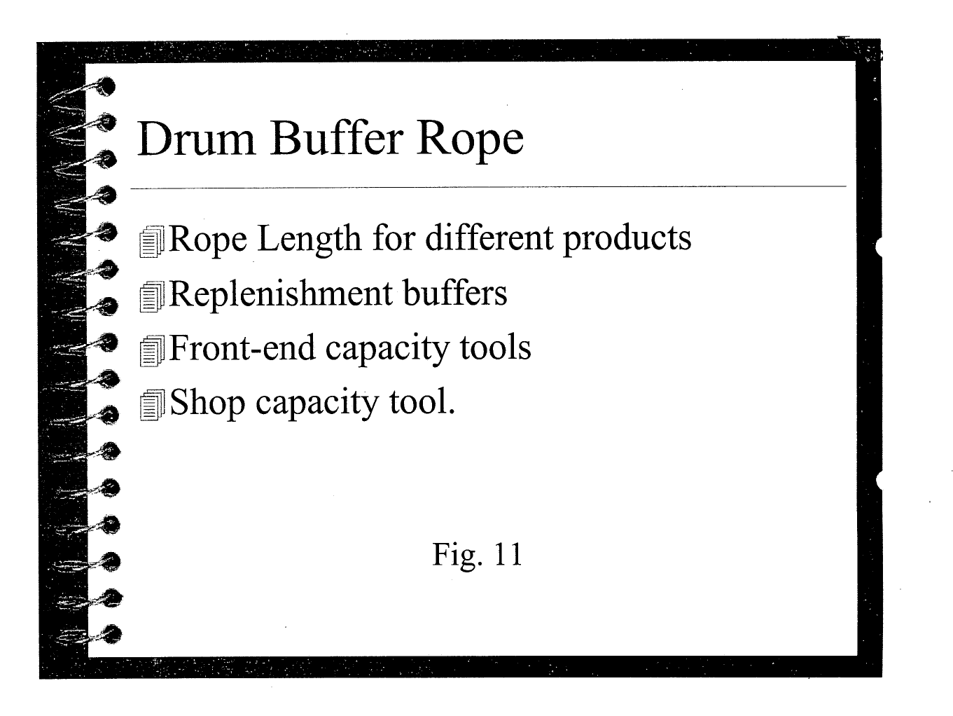

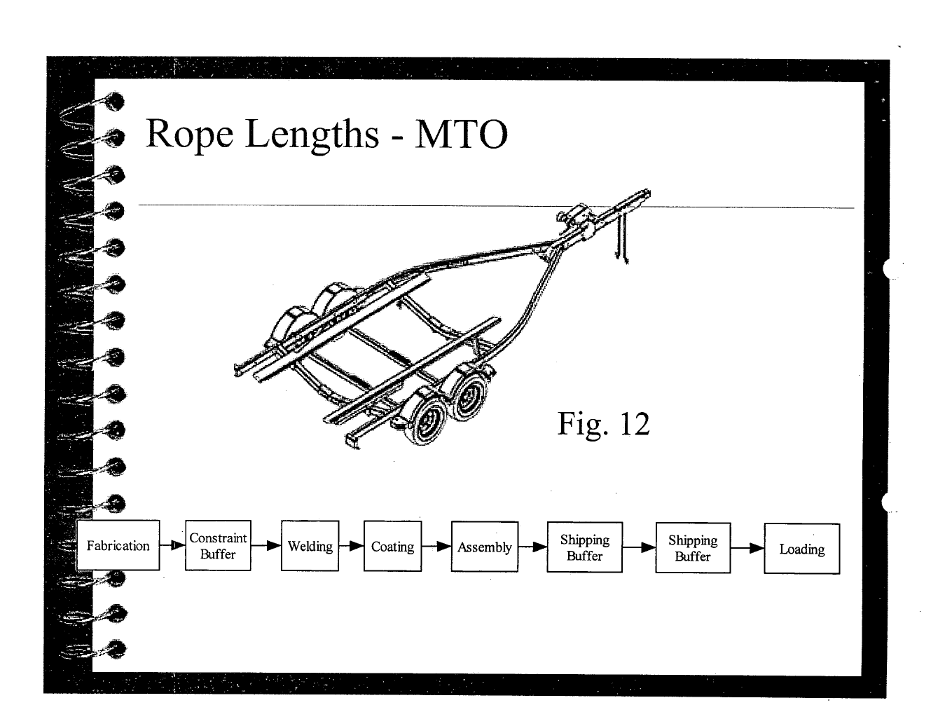

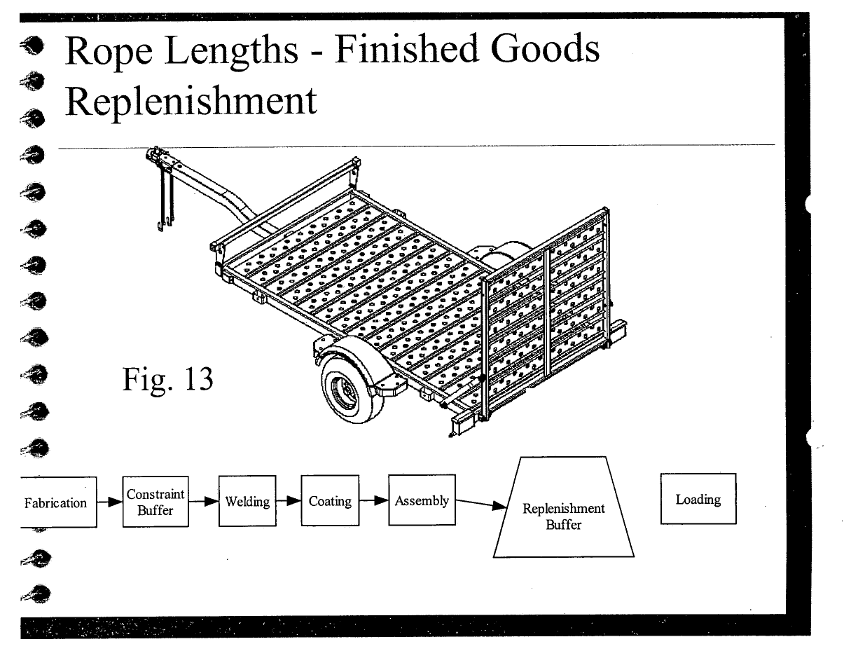

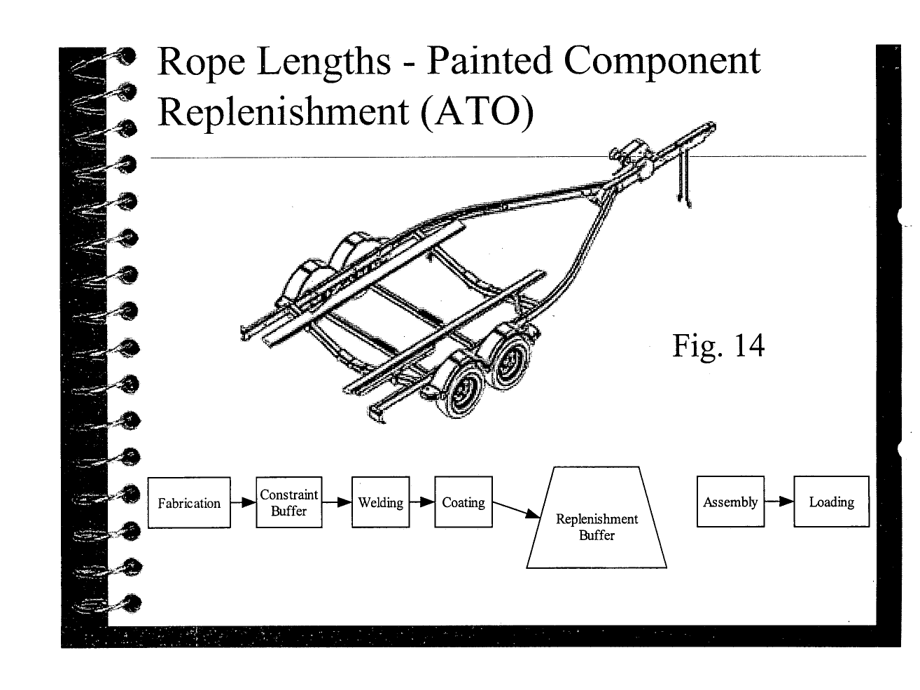

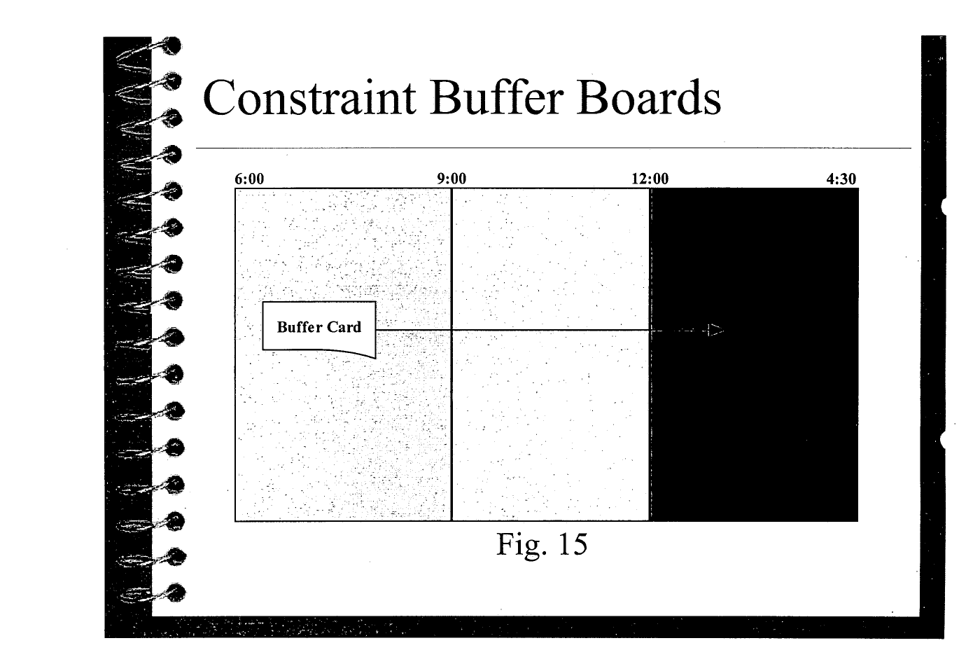

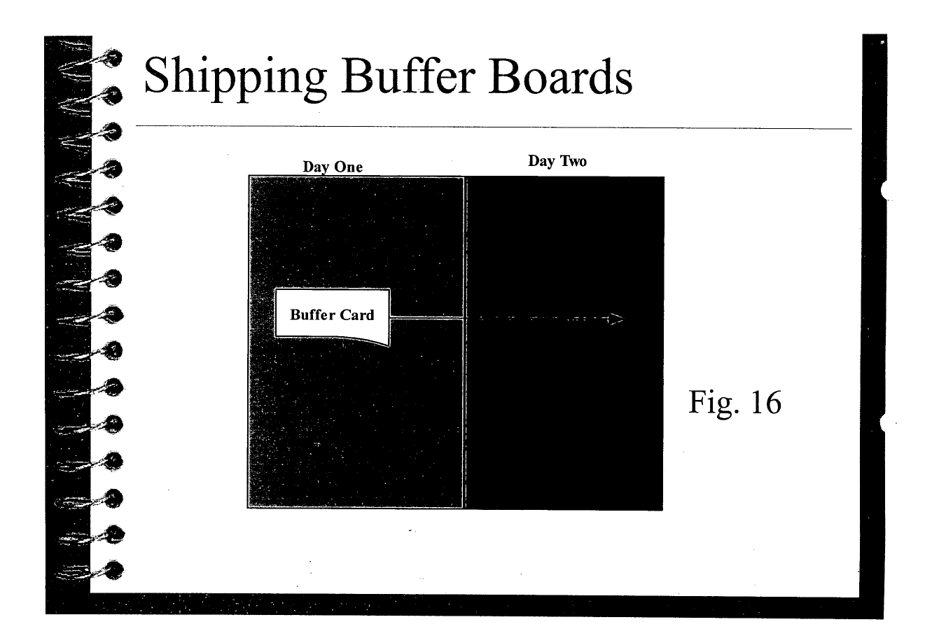

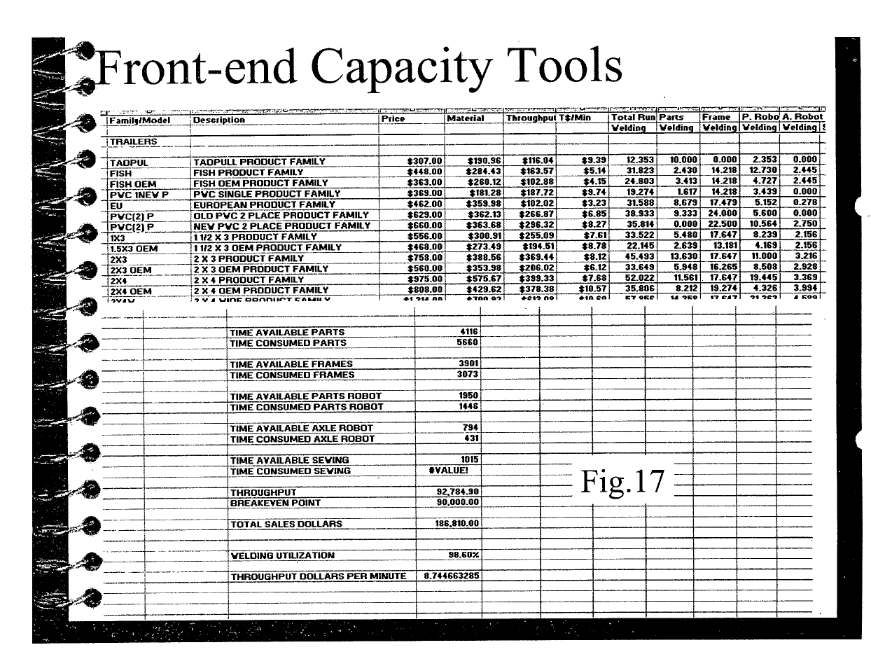

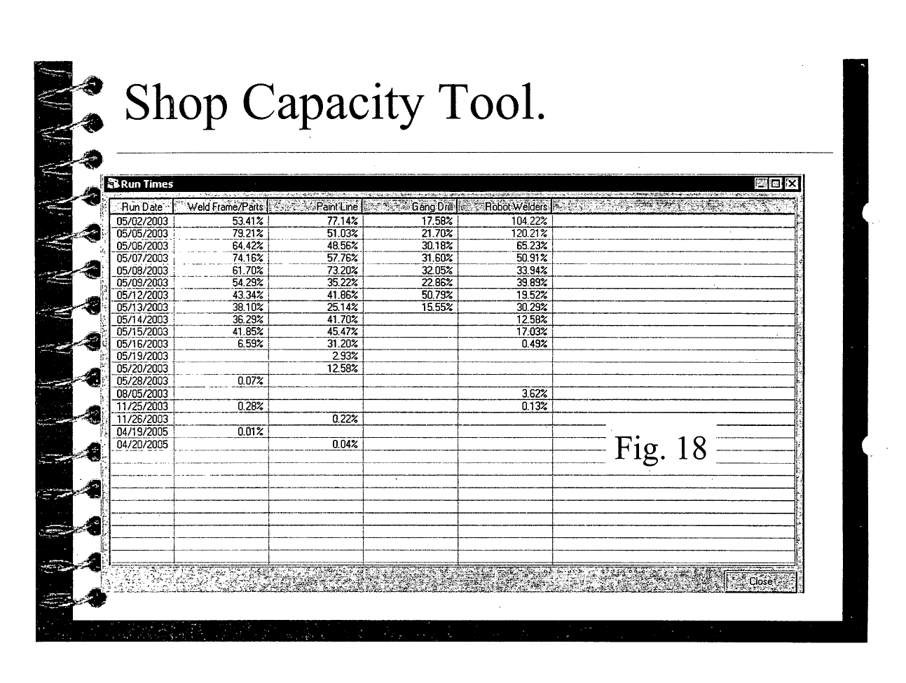

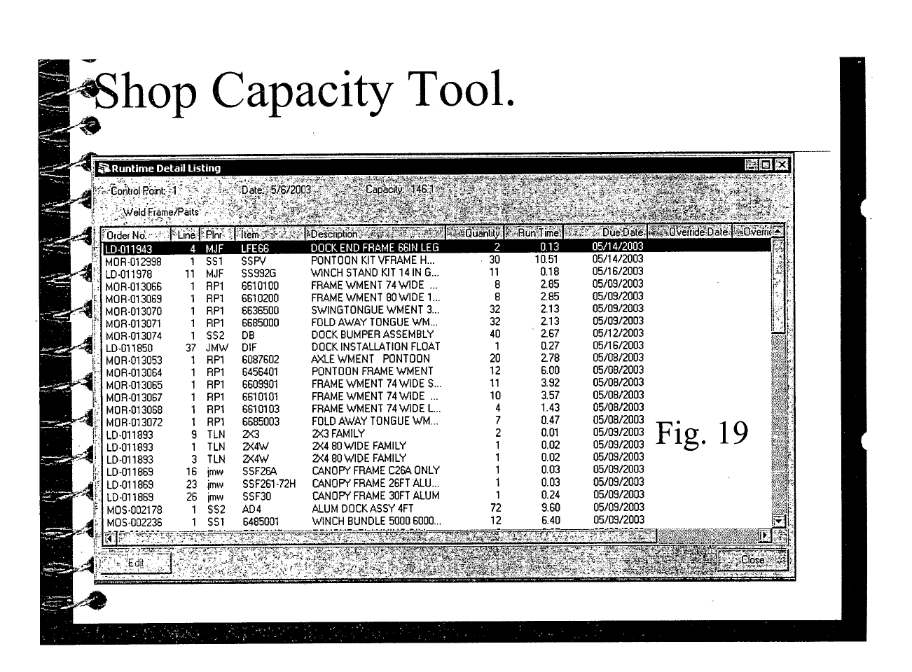

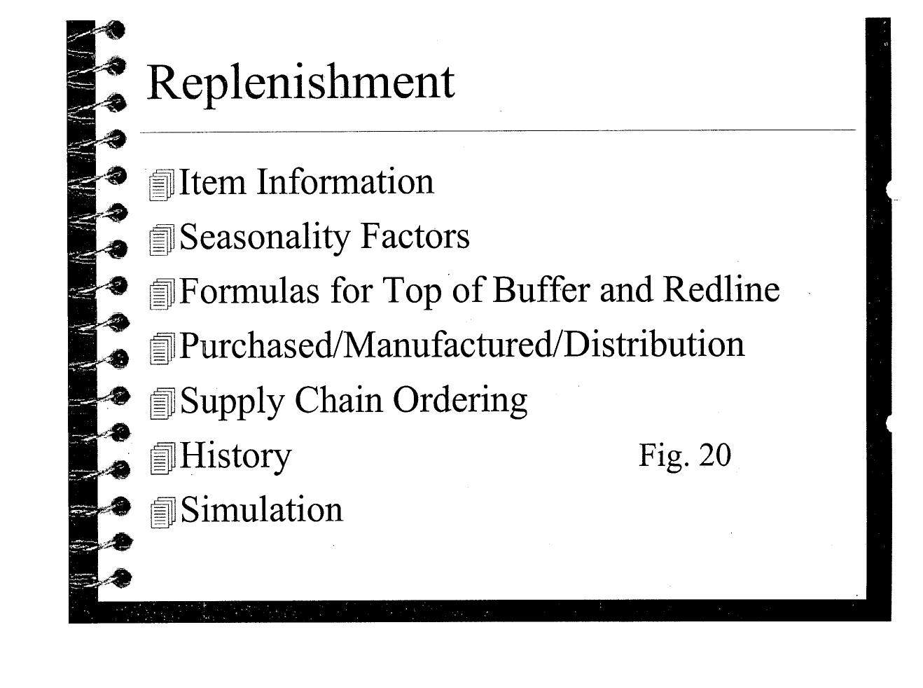

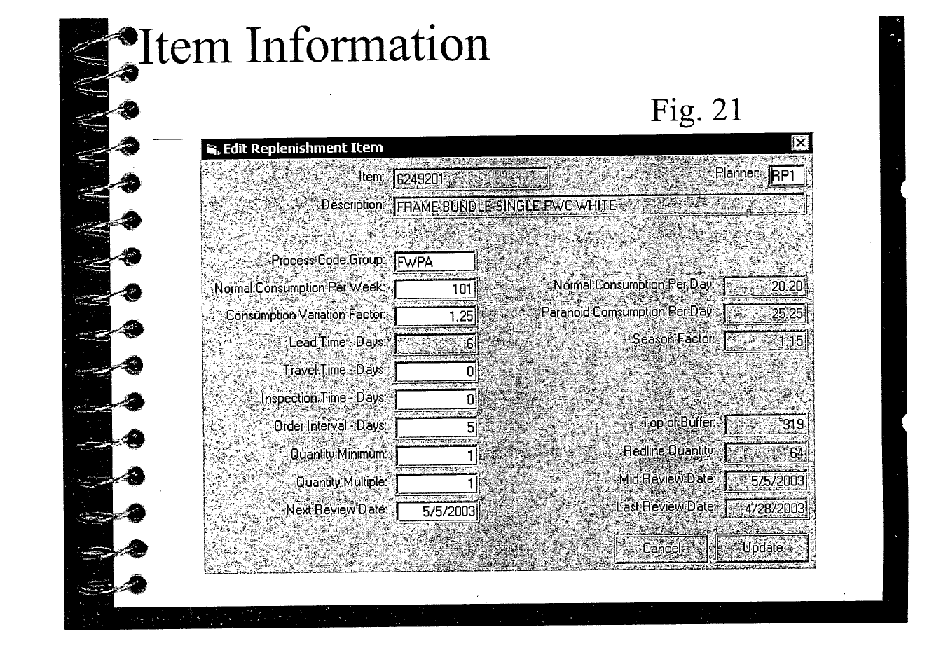

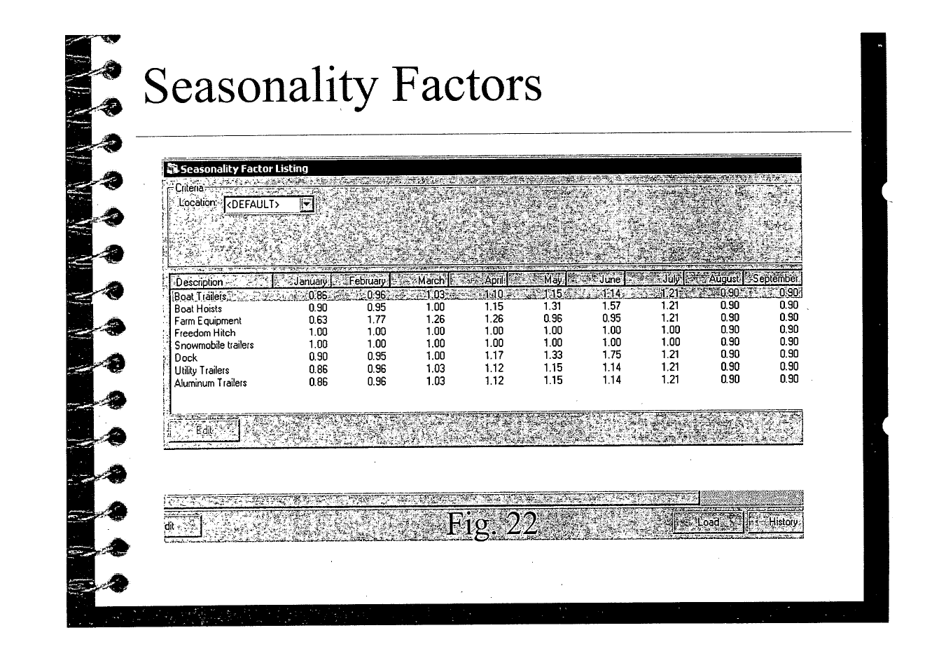

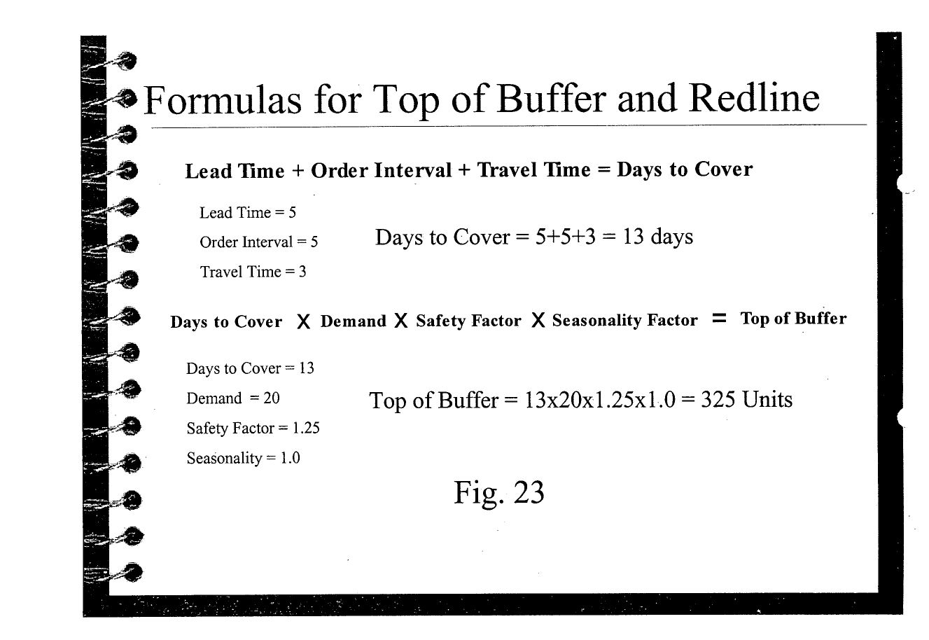

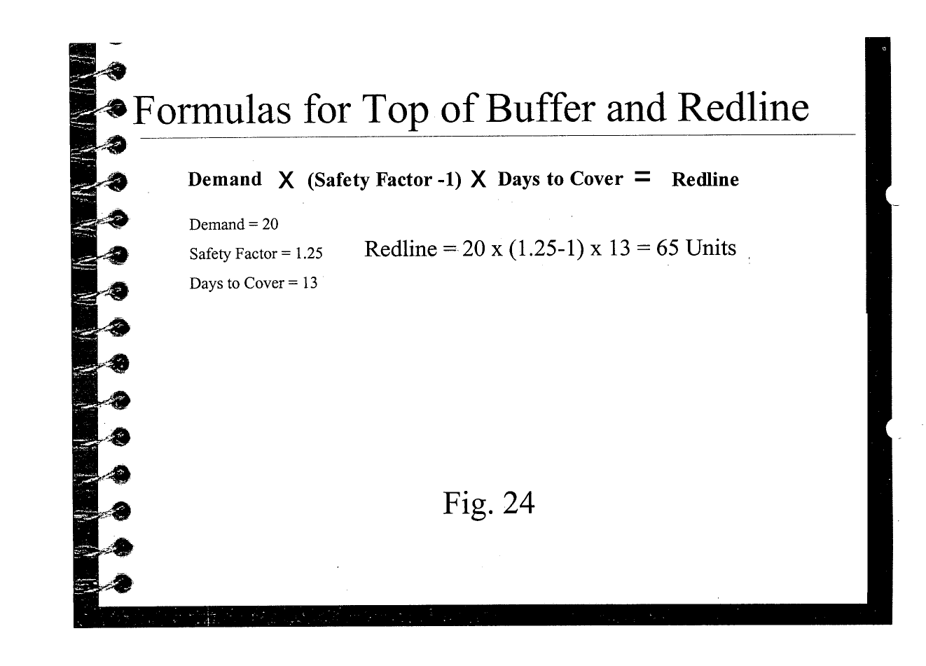

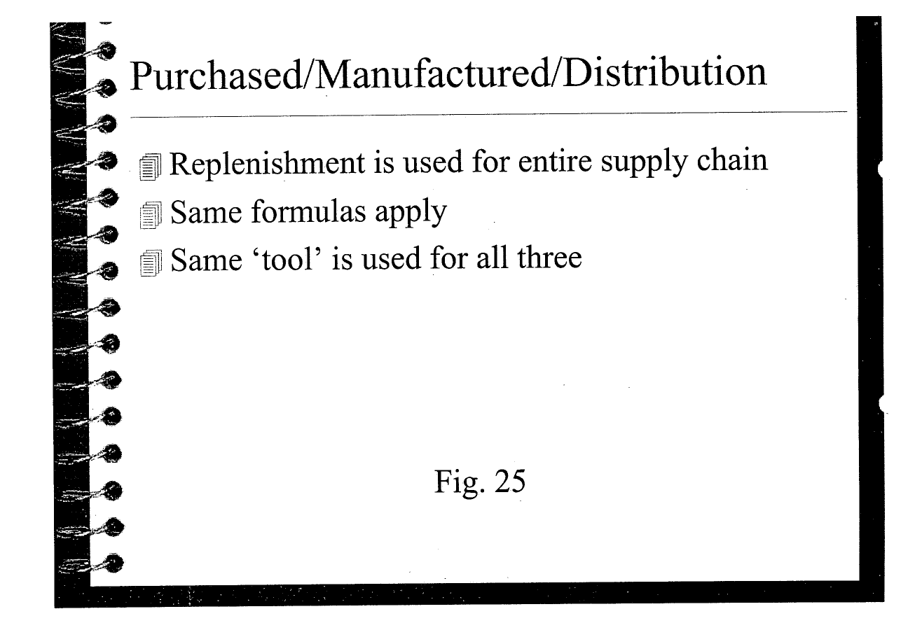

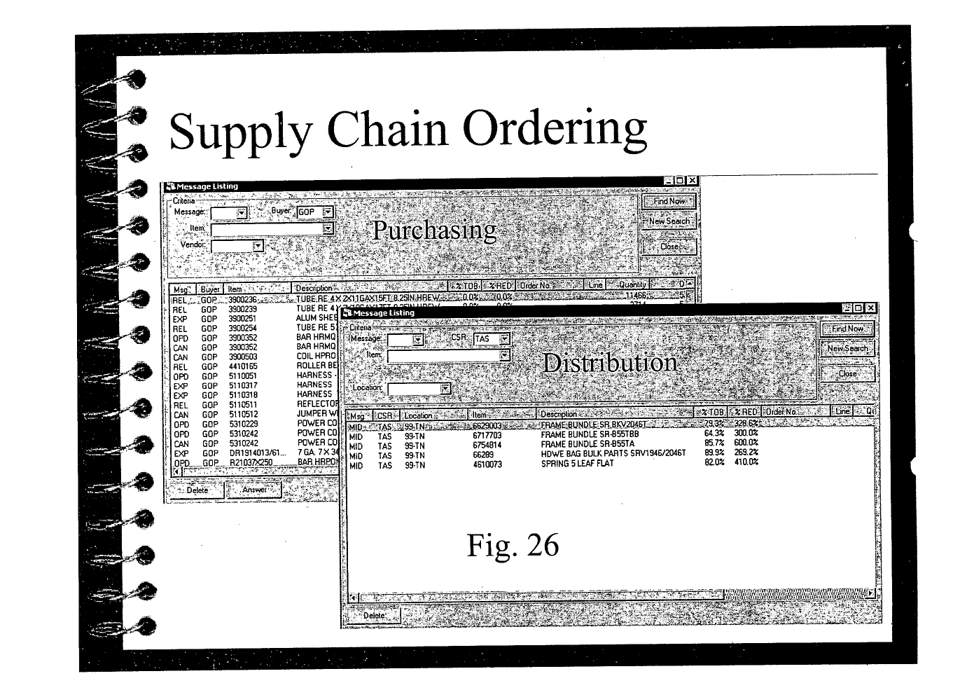

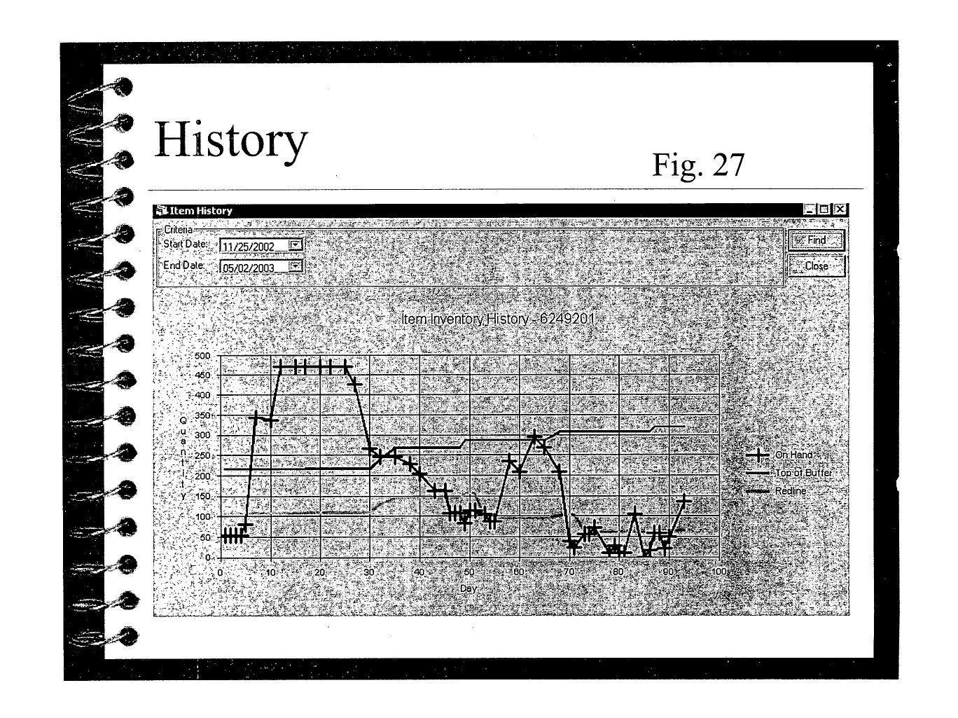

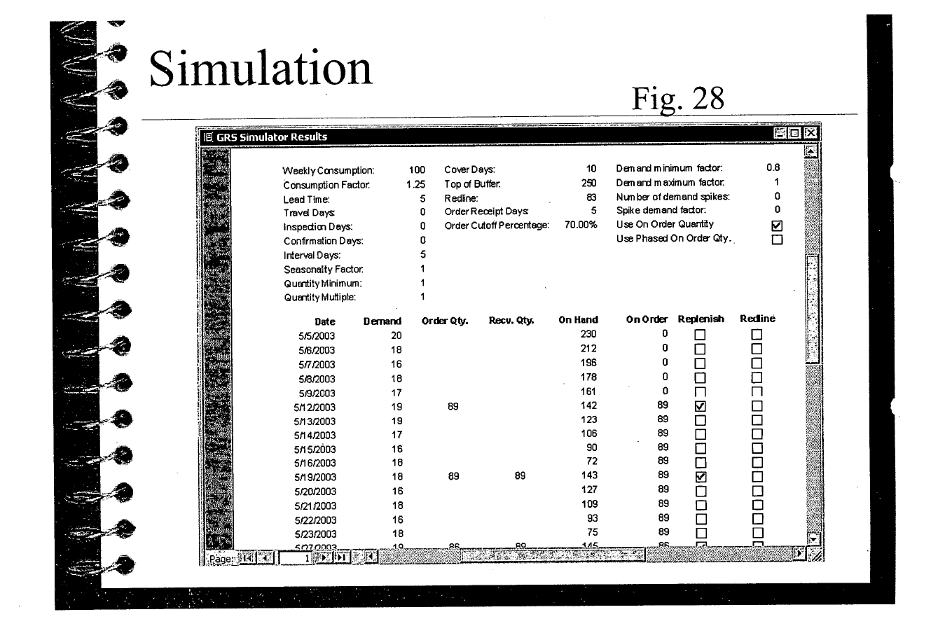

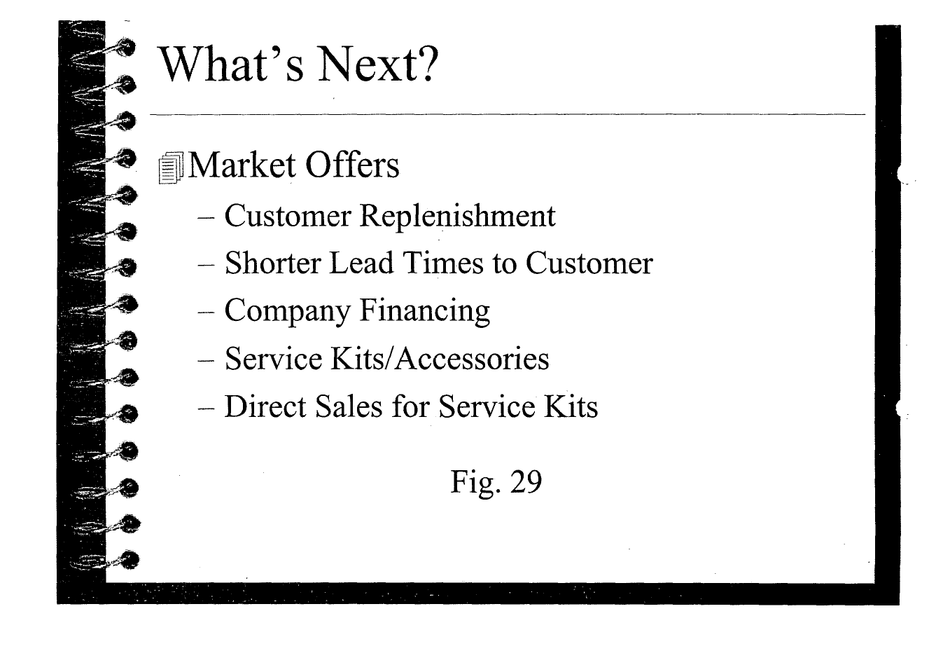

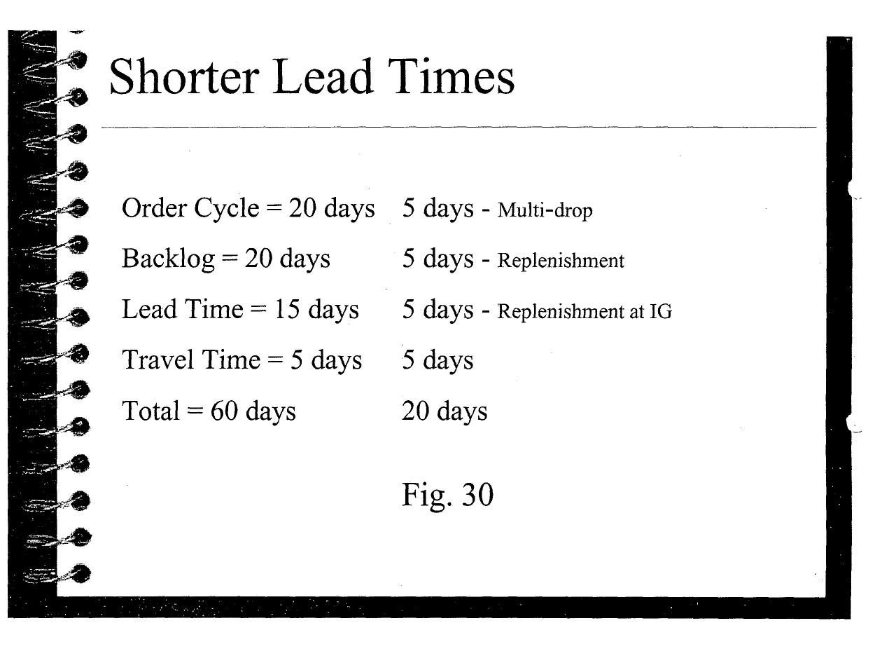

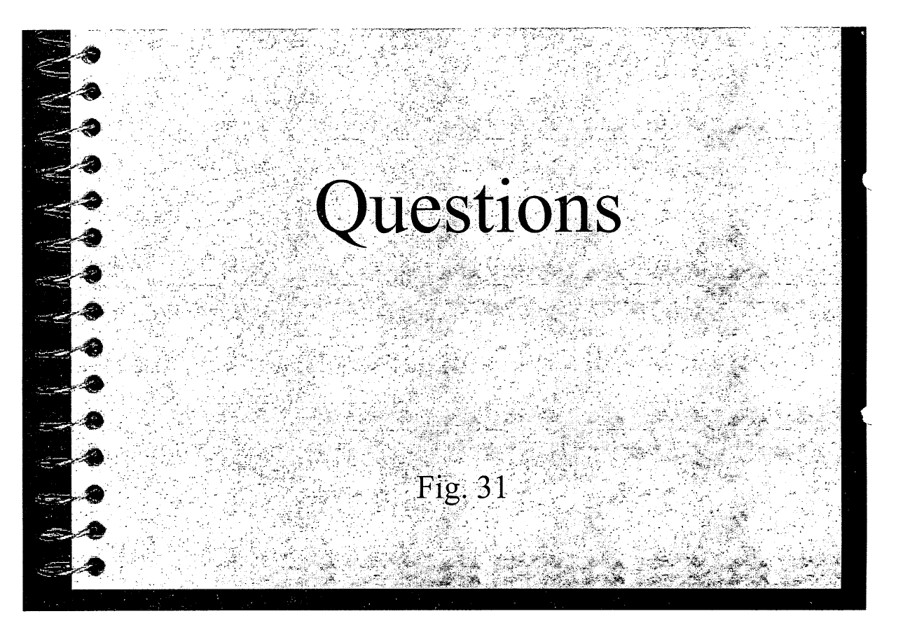

FIGS. 9-31 illustrate a complete presentation, explaining the present invention.

The above embodiment is the preferred embodiment, but this invention is not limited thereto. It is, therefore, apparent that many modifications and variations of the present invention are possible in light of the above teachings. It is, therefore, to be understood that within the scope of the appended claims, the invention may be practiced otherwise than as specifically described.

1. A method for replenishing an inventory of final products, the method comprising:
(a) determining an appropriate time period, based on a process cycle time, at which to review said inventory; and
(b) replenishing the inventory as consumed during each of said time periods.

2. The method of claim 1, wherein the reviewed inventory is compared to an upper inventory limit value.

3. The method of claim 2 wherein the upper inventory limit value varies as a function of time.

4. The method of claim 2 wherein the upper inventory limit value is calculated as a function of product lead time.

5. The method of claim 2 wherein the upper inventory limit value is calculated as a function of product order cycle.

6. The method of claim 2 wherein the upper inventory limit value is calculated as a function of product travel time.

7. The method of claim 2 wherein the upper inventory limit value is calculated as a function of a final product's safety factor.

8. The method of claim 1 wherein a need for replenishment is determined when the reviewed inventory drops below a predetermined value.

9. The method of claim 8 wherein the predetermined value is a predetermined fraction of an upper inventory limit value.

10. The method of claim 1 wherein the reviewed inventory is compared to a lower inventory limit.

11. The method of claim 10 wherein a warning is given if the reviewed inventory is less than the lower inventory limit.

12. The method of claim 1 wherein raw materials are purchased based on a consumption of raw materials since a previous review cycle compared to an upper inventory limit.

13. The method of claim 1 wherein the final products are used as parts of consumer goods.

14. A method for scheduling a manufacture of a finished product, the method comprising the steps of:
(a) determining an appropriate time period at which to review an inventory of the finished product as a function of various criteria comprising sales volume, logistics, business objective for inventory, and lead times;
(b) reviewing said inventory at the time determined;
(c) determining a proposed manufacturing schedule if the inventory requires replenishing;
(d) reviewing at least one capacity-constrained resource's capacity to ascertain that the proposed manufacturing schedule does not exceed the at least one capacity-constrained resource's capacity; and
(e) adjusting the manufacturing schedule based on the capacity-constrained resource's capacity, if needed.

15. A global replenishment system for scheduling a replenishment of inventory of a final product, the system comprising a module for notifying an operator of a time for reviewing the inventory of the final product, said time based on an inventory review period for the final product calculated as a function of a process cycle time.

16. The global replenishment system of claim 15 additionally comprising a processing function including a calculation for an upper inventory limit value for the final product.

17. The global replenishment system of claim 16 wherein the processing function also includes a calculation for comparing an inventory of the final product with the upper inventory limit value.

18. The global replenishment system of claim 15 additionally comprising a processing function including a calculation for a lower inventory limit value for the final product.

19. The global replenishment system of claim 18 wherein the processing function also includes a calculation for comparing an inventory of the final product with the lower inventory limit value.

20. The global replenishment system of claim 19 additionally comprising a warning if the inventory of the final product is less than the lower inventory limit value.

21. The global replenishment system of claim 15 additionally comprising a processing function including a calculation for determining appropriate raw material purchasing times based on the history replenishment of the inventory of final products.

22. The global replenishment system of claim 21 wherein the processing function also includes a calculation for determining an appropriate purchase order for raw materials.

23. A global replenishment system for scheduling a manufacture of a finished product, the system comprising:
(a) calculation means for determining an appropriate time period at which to review an inventory of the finished product as a function of lead time;
(b) a user interface for presenting data for a review of said inventory at the time determined;
(c) a manufacture scheduler for determining a proposed manufacturing schedule if the inventory requires replenishing; and
(d) a comparator for reviewing at least one capacity-constrained resource's capacity to ascertain that the proposed manufacturing schedule does not exceed the at least one capacity-constrained resource's capacity.

24. The method of claim 1 wherein the appropriate time period is also based on a machine setup time for the final product's production.

25. The method of claim 1 wherein the appropriate time period is also based on a volume of final product to be built.

26. The method of claim 1 wherein the appropriate time period is also based on inventory strategies for the final product.

27. The global replenishment system of claim 15 wherein the inventory review period for the final product is also calculated as a function of a machine setup time for the final product's production.

28. The global replenishment system of claim 15 wherein the inventory review period for the final product is also calculated as a function of a volume of final product to be built.

29. The global replenishment system of claim 15 wherein the inventory review period for the final product is also calculated as a function of inventory strategies for the final product.
